(19) United States
(12) Patent Application Publication
(10) Pub. No.: US 2026/0145450 A1
(43) Pub. Date: May 28, 2026

(54) SHEET CONVEYING DEVICE AND IMAGE FORMING SYSTEM

(71) Applicant: CANON KABUSHIKI KAISHA, Tokyo (JP)

(72) Inventor: KAZUNORI ISHII, Ibaraki (JP)

(21) Appl. No.: 19/345,146

(22) Filed: Sep. 30, 2025

(30) Foreign Application Priority Data
Nov. 26, 2024 (JP) 2024-205190

(51) Int. Cl. B41J 29/13; B41J 3/60; B41J 13/10

(52) U.S. Cl. CPC B41J 29/13; B41J 3/60; B41J 13/103

(57) ABSTRACT

A sheet conveying device includes a conveyance guide supported by a supporting portion, openable and closable between a closed position where a sheet passage through which a sheet is conveyed is formed and an opening position where the sheet passage is opened, an interlocking portion engaged with the conveyance guide and the supporting portion, and to move in interlocking with opening/closing of the conveyance guide, and an urging portion to apply an urging force to the interlocking portion and the conveyance guide in a direction for opening the conveyance guide. The urging force is larger than a first force acting on the interlocking portion in a direction for closing the conveyance guide in a case of the opening position of the conveyance guide, and is smaller than a second force acting on in the direction for closing the conveyance guide in a case of the closed position.

### BACKGROUND

### Field of the Technology

The present disclosure relates to a sheet conveying device which conveys a sheet and an image forming system.

### Description of the Related Art

In an image forming apparatus, a sheet conveying device which conveys a sheet is provided. In the sheet conveying device, as disclosed in Japanese Patent Application Laid-Open No. 2012-12170, in order to open a sheet conveyance passage in a case in which the sheet is jammed in the sheet conveyance passage, etc., a conveyance guide is configured to be movable to an opening position. The conveyance guide is configured, so as not to fall naturally from the opening position and move to a position closing the sheet conveyance passage, to maintain the position opening the sheet conveyance passage by using a spring. In addition, the conveyance guide is configured such that, in a process of a user moving the sheet conveyance passage from the opening position to the closed position, from the position opening the conveyance guide to the position closing the conveyance guide, an urging force of the spring is switched.

However, as in Japanese Patent Application Laid-Open No. 2012-12170, upon moving the conveyance guide to the closed position, the urging force of the spring acts in a closing direction. Therefore, upon the user attempting to close the conveyance guide, the conveyance guide may be closed with great force. As a result, the conveyance guide may be damaged, so that it is necessary for the user to operate the conveyance guide carefully, which is not good for operability.

### SUMMARY

An object of the present disclosure is to provide a sheet conveying device and an image forming system capable of improving operability upon opening/closing a conveyance guide portion.

An aspect of the present invention is a sheet conveying device comprising: a supporting portion; a conveyance guide portion supported by the supporting portion, openable and closable between a closed position where a sheet conveyance passage through which a sheet is conveyed is formed and an opening position where the sheet conveyance passage is opened, and configured to guide the sheet; an interlocking portion engaged with the conveyance guide portion and the supporting portion, and configured to move in interlocking with opening/closing of the conveyance guide portion; and an urging portion configured to apply an urging force to the interlocking portion and the conveyance guide portion in a direction for opening the conveyance guide portion toward the opening position, wherein the urging force is larger than a first force acting on the interlocking portion in a direction for closing the conveyance guide portion in a case in which the conveyance guide portion is in the opening position, and smaller than a second force acting on the interlocking portion in the direction for closing the conveyance guide portion in a case in which the conveyance guide portion is in the closed position.

Further features of the present invention will become apparent from the following description of exemplary embodiments with reference to the attached drawings.

### BRIEF DESCRIPTION OF THE DRAWINGS

FIG. 1 is a schematic view illustrating an outline configuration of an inkjet recording system according to the present Embodiment.

FIG. 2A is a perspective view illustrating a feeding module according to the present Embodiment.

FIG. 2B is a front view illustrating a conveyance passage of the feeding module according to the present Embodiment.

FIG. 3 is a front view illustrating a main assembly of the feeding module according to the present Embodiment.

FIG. 4 is a perspective view seen from a right front side illustrating the main assembly of the feeding module according to the present Embodiment.

FIG. 5 is a front view illustrating a vertical conveyance entrance unit when a conveyance guide according to the present Embodiment is in a closed position.

FIG. 6 is a perspective view illustrating a portion of a link mechanism and a torsion coil spring when the conveyance guide according to the present Embodiment is in the closed position.

FIG. 7 is a front view illustrating the vertical conveyance entrance unit when the conveyance guide according to the present Embodiment is in an opening position.

FIG. 8 is a perspective view illustrating the portion of the link mechanism and the torsion coil spring when the conveyance guide according to the present Embodiment is in the opening position.

FIG. 9 is a front view illustrating the vertical conveyance entrance unit when the conveyance guide according to the present Embodiment is in an intermediary position.

FIG. 10 is a perspective view illustrating the portion of the link mechanism and the torsion coil spring when the conveyance guide according to the present Embodiment is in the intermediary position.

FIG. 11A is a perspective view illustrating a portion of a link mechanism and a torsion coil spring when a conveyance guide according to another Embodiment is in a closed position.

FIG. 11B is a perspective view illustrating the portion of the link mechanism and the torsion coil spring when the conveyance guide according to the other Embodiment is in an intermediary position.

FIG. 11C is a perspective view illustrating the portion of the link mechanism and the torsion coil spring when the conveyance guide according to the other Embodiment is in an opening position.

### DESCRIPTION OF THE EMBODIMENTS

Hereinafter, the present Embodiment will be described in detail with reference to the drawings.

### Configuration of an Inkjet Recording System

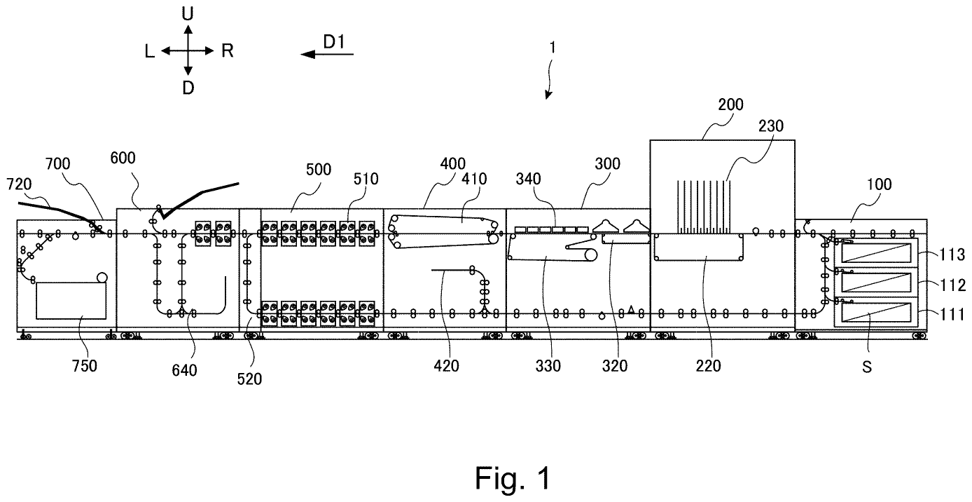

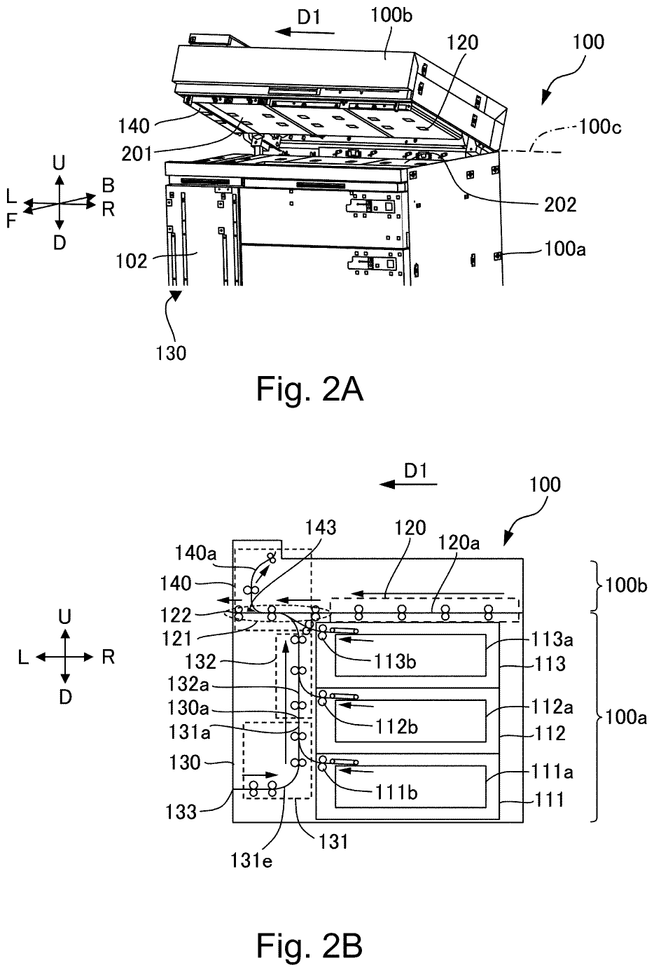

First, a configuration of an inkjet recording system 1 as an image forming system in the present Embodiment will be described using FIG. 1 and FIG. 2. FIG. 1 is a schematic view illustrating an example of an outline configuration of an inkjet recording system 1. FIG. 2A is a perspective view illustrating a feeding module according to the present Embodiment. FIG. 2B is a front view illustrating a conveyance passage of the feeding module according to the present Embodiment. This inkjet recording system 1 is an inkjet recording system of a sheet-feeding type, which produces a recorded product in which an ink image is formed on a sheet S using two liquids of reaction fluid and ink.

As shown in FIG. 1, the inkjet recording system 1 is constituted by a feeding module 100, a printing module 200, a drying module 300, a fixing module 400, a cooling module 500, a reversing module 600 and a discharging module 700. The sheet S in a cut paper shape supplied from the feeding module 100 is conveyed along a conveyance passage, processed by each module, and discharged by the discharging module 700. Incidentally, the sheet in the present Embodiment is a recording material, and includes a paper such as a sheet and an envelope, a plastic film such as a sheet for an overhead projector (OHP), cloth, etc. In addition, in the present Embodiment, a sheet conveyance direction D1 is arranged to be a left-right direction of the inkjet recording system 1, and it will be described that a right side upon facing the system as a right direction R, a left side upon facing the system as a left direction L, a front side as a front direction F, a back side as a back direction B, an upside as an up direction U, and a downside as a down direction D.

The feeding module 100 as a sheet conveying device conveying the sheet supplies, by being connected to the printing module 200 and conveying the sheet, the sheet to the printing module 200, and performs sending and receiving of the sheet with the printing module 200. The feeding module 100 includes, as a sheet supplying unit which accommodates and feeds the sheet S, a first supplying unit 111, a second supplying unit 112 and a third supplying unit 113. As shown in FIG. 2B, the first supplying unit 111 includes a first accommodating portion 111a which accommodates the sheet S and a first feeding portion 111b which feeds the sheet S from the first accommodating portion 111a. The second supplying unit 112 includes a second accommodating portion 112a which accommodates the sheet S and a second feeding portion 112b which feeds the sheet S from the second accommodating portion 112a. The third supplying unit 113 includes a third accommodating portion 113a which accommodates the sheet S and a third feeding portion 113b which feeds the sheet S from the third accommodating portion 113a. The first accommodating portion 111a, the second accommodating portion 112a and the third accommodating portion 113a are configured to be capable of accommodating a plurality of the sheets, respectively, and are configured to be drawable to the front side of the device, respectively. The sheet S is separated and fed one by one by the first feeding portion 111b, the second feeding portion 112b and the third feeding portion 113b in the first accommodating portion 111a, the second accommodating portion 112a and the third accommodating portion 113a, respectively, and is conveyed to the printing module 200. Incidentally, it is not limited for a number of the supplying unit to be three, but it may be a configuration which includes one, two, or four or more of the supplying unit. The feeding module 100 will be described later.

As shown in FIG. 1, the printing module 200 is an example of an image forming apparatus, includes a pre image forming registration correcting portion, a printing belt unit 220 and a recording portion 230, and conveys the sheet S. The sheet S conveyed from the feeding module 100 is conveyed to the printing belt unit 220 after a tilt and a position of the sheet S are corrected by the pre image forming registration correcting portion. The recording portion 230 is disposed at a position, with respect to the conveyance passage, opposite to the printing belt unit 220.

The recording portion 230 is an example of an image forming portion, and forms an image by performing a recording process (printing) on the sheet S with a recording head from above with respect to the conveyed sheet S. A plurality of the recording heads are lined up along the sheet conveyance direction D1. In the present Embodiment, a total of five recording heads of line type corresponding to four colors of Y (yellow), M (magenta), C (cyan) and Bk (black), and the reaction fluid are provided. Incidentally, the number of colors and the number of the recording heads are not limited to four and five, respectively. As an inkjet type, a type using a heat-generating element, a type using a piezoelectric element, a type using an electrostatic element, a type using an MEMS element, etc. can be employed. The ink of each color is supplied from an ink tank to the recording head via an ink tube. The sheet S printed in the recording portion 230 is conveyed, by being suctioned and conveyed by the printing belt unit 220, while ensuring clearance with the recording heads. As for the sheet S printed in the recording portion 230, misalignment and color density of the image formed on the sheet S is detected by an in-line scanner disposed on a downstream side of the recording portion in the sheet conveyance direction D1. A detection result thereof is used for correction of a print image.

The drying module 300 is provided with a decoupling portion 320, a drying belt unit 330 and a hot air blowing portion 340, reduces a liquid content contained in the ink applied onto the sheet S in the recording portion 230 of the printing module 200, and enhances fixing performance of the ink to the sheet S. The sheet S printed in the recording portion 230 of the printing module 200 is conveyed to the decoupling portion 320, which is disposed on an upstream side of the drying module 300 in the sheet conveyance direction D1. The decoupling portion 320 can convey the sheet S with wind pressure from above and friction of a belt, and prevents misalignment of the sheet S on the printing belt unit 220, on which the ink image is formed, by weakly holding and conveying the sheet S on the belt. The drying belt unit 330 is disposed below the belt, and the hot air blowing portion 340 is disposed above the belt, opposing each other across the belt. The sheet S conveyed from the decoupling portion 320 is suctioned and conveyed by the drying belt unit 330, and at the same time, a surface on which the ink is applied is dried by receiving hot wind from the hot air blowing portion 340. Incidentally, as for a drying type, in addition to the type applying the hot wind, it may be configured by combining a type irradiating the surface of the sheet S with electromagnetic waves (such as ultraviolet rays or infrared rays) and a conduction heat transfer type by a contact of a heat generating element.

The fixing module 400 includes a fixing belt unit 410. The fixing belt unit 410 includes an upper belt unit and a lower belt unit, and can fix the ink to the sheet S by causing the sheet S conveyed from the drying module 300 to pass through between the heated upper belt unit and the lower belt unit.

The cooling module 500 is provided with a plurality of cooling portions 510, and cools the sheet S of high temperature conveyed through the sheet conveyance passage from the fixing module 400. The cooling portion 510 is configured to cool the sheet S by sucking outside air into a cooling box with a fan, increasing pressure in the cooling box, and applying wind blown out from a nozzle which is formed on a conveyance guide to the sheet S. The cooling portion 510 is disposed on both of an upside and a downside with respect to the sheet conveyance passage, and cools the sheet S from both sides.

In addition, the cooling module 500 includes a conveyance passage switching portion, and can switch the conveyance passage of the sheet S depending on a case in which the sheet S is conveyed to the reversing module 600 and a case in which the sheet S is conveyed to a double-side conveyance passage, which is used upon a double-side printing. During double-side printing, the sheet S is conveyed to a conveyance passage in a lower portion of the cooling module 500. In this case, the sheet S is further conveyed along the double-side conveyance passage of the cooling module 500, the fixing module 400, the drying module 300, the printing module 200 and the feeding module 100. To the double-side conveyance passage of the fixing module 400, a first reversing portion 420 which reverses a front and a back of the sheet S is provided. And, again, the sheet S is conveyed from the feeding module 100 to the pre image forming registration correcting portion of the printing module 200, the printing belt unit 220 and the recording portion 230, and printed in the recording portion 230.

The reversing module 600 includes a second reversing portion 640, and can reverse the front and the back of the sheet S to be conveyed and change a front-back orientation of the sheet S to be discharged. The discharging module 700 includes a top tray 720 and a stacking portion 750, and aligns and stacks the sheet S conveyed from the reversing module 600.

### Feeding Module

Next, a configuration of the feeding module 100 will be described using FIG. 2A and FIG. 2B. As shown in FIG. 2A and FIG. 2B, the feeding module 100 includes a main assembly 100a, in which each supplying unit is accommodated, and an upper door 100b, which is connected to the back direction B side of the main assembly 100a by a hinge and is opened upward. The upper door 100b is supported rotatably about a rotation shaft 100c with respect to the main assembly 100a, and is movable between a closed position (see FIG. 2B) closed with respect to the main assembly 100a and an opening position (see FIG. 2A) opened with respect to the main assembly 100a. In the present Embodiment, the rotation shaft 100c is disposed with the sheet conveyance direction D1 of the sheet S to be conveyed as an axial direction. However, the axial direction of the rotation shaft 100c is not limited to the sheet conveyance direction D1. In addition, arrows in FIG. 2B indicate the sheet conveyance directions in each of the conveyance passages.

The feeding module 100 includes a horizontal conveying portion 120, a vertical conveying portion 130 and an escape conveying portion 140. The horizontal conveying portion 120 includes a horizontal conveyance passage 120a which is horizontal, the vertical conveying portion 130 includes a vertical conveyance passage 130a in which the sheet S is conveyed in the up direction U, and the escape conveying portion 140 includes an escape conveyance passage 140a in which the sheet S is conveyed in the up direction U. Downstream of the horizontal conveyance passage 120a in the sheet conveyance direction D1, a discharging passage 121, which is formed by an upper portion of the vertical conveying portion 130 and a lower portion of the escape conveying portion 140, is continuously provided.

The vertical conveying portion 130 is an example of a conveying unit, and conveys the sheets S supplied from the first supplying unit 111, the second supplying unit 112 and the third supplying unit 113 to the recording portion 230, respectively (see FIG. 1). In a case in which the sheet S is supplied from the feeding module 100 to the printing module 200, which is disposed downstream in the sheet conveyance direction D1, the following operations are executed. That is, in a case of printing a first side of the sheet S, the sheet S is supplied from the first supplying unit 111, the second supplying unit 112 and the third supplying unit 113. In a case of printing a second side of the sheet S, the sheet S is supplied from a re-conveyance passage provided at a lower portion of the printing module 200 (see FIG. 1) via a vertical conveyance entrance 133 through the vertical conveyance passage 130a of the vertical conveying portion 130. Each supplied sheet S is conveyed from the discharging passage 121 via a discharging port 122 to the printing module 200. The vertical conveying portion 130 will be described later.

In the discharging passage 121, a switching portion 143 is provided. The switching portion 143 is capable of switching the conveyance passage by being rotated, and switches whether conveying the sheet S conveyed through the discharging passage 121 to the discharging port 122 or to the escape conveyance passage 140a of the escape conveying portion 140. In a case in which a jam or malfunction occurs during printing, the switching portion 143 switches the conveyance passage of the sheet to the escape conveyance passage 140a of the escape conveying portion 140, and causes the sheets which are being retained in the conveyance passage to be ejected to a discharge tray provided to an upper portion of the feeding module 100.

Incidentally, in the present inkjet recording system 1, to the feeding module 100, the same feeding module 100 can be connected upstream thereof in the sheet conveyance direction D1, for example. In this case, the discharging port 122 of the feeding module 100, which is disposed upstream in the sheet conveyance direction D1, is connected to the horizontal conveyance passage 120a of the feeding module 100, which is disposed downstream in the sheet conveyance direction D1. In other words, the same feeding module 100, which is disposed upstream in the sheet conveyance direction D1, can feed the sheet S set in each feeding unit to the horizontal conveyance passage 120a of the feeding module 100, which is disposed downstream in the sheet conveyance direction D1. By this, as the inkjet recording system 1, the accommodating portion in which the sheet can be set can be doubled. In addition, three or more of the feeding modules 100 may be connected.

And, in the feeding module 100 described above, in a case in which the jam of the sheet occurs in the horizontal conveyance passage 120a, etc., by opening the upper door 100b described above upward, it becomes possible to check and remove the jammed sheet. In addition, in a case in which the malfunction occurs in the feeding module, by opening the upper door 100b upward, it becomes possible to perform maintenance, etc.

### Vertical Conveying Portion

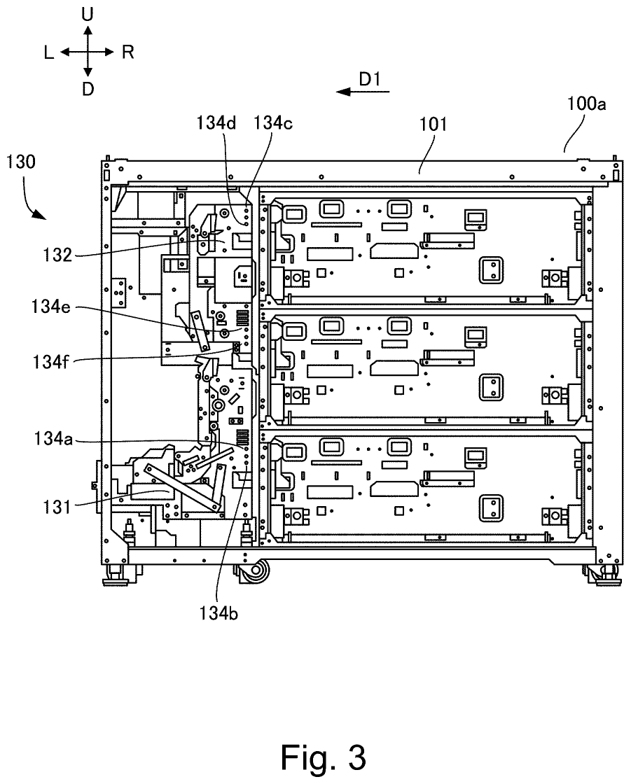

The vertical conveying portion 130 will be described using FIG. 2B and FIG. 3. FIG. 3 is a front view of the main assembly 100a illustrating details of a first conveying portion 131 and a second conveying portion 132. The vertical conveying portion 130 includes the first conveying portion 131 and the second conveying portion 132. The first conveying portion 131 receives the sheet S supplied from the first supplying unit 111, and conveys the sheet S in a first conveyance passage 131a. The second conveying portion 132 receives the sheet supplied from the second supplying unit 112, and conveys the sheet S in a second conveyance passage 132a.

The second conveyance passage 132a is continuous, in a case in which the second conveying portion 132 is coupled to the first conveying portion 131, to the first conveyance passage 131a. The discharging passage 121 is continuous, in a case in which the escape conveying portion 140 is mounted on the main assembly 100a, to the second conveyance passage 132a. The first conveying portion 131 includes a re-conveyance passage 131e, which receives the sheet, via the vertical conveyance entrance 133, which is re-conveyed to form the image on the second side of the opposite side to the first side after the image is formed on the first side in the recording portion 230, and conveys the sheet S to the first conveyance passage 131a.

The main assembly 100a includes, as shown in FIG. 3, a frame 101. In the present Embodiment, the frame 101 means a frame member having an approximately rectangular shape constituted by a plurality of frames having a rod shape being coupled. The first conveying portion 131 is in a state of being fixed to the front direction F side of the frame 101 by screws 134a and 134b. The second conveying portion 132 is in a state of being fixed to the front direction F side of the frame 101 by screws 134c, 134d, 134e and 134f.

### Moving Mechanism for the Vertical Conveying Portion

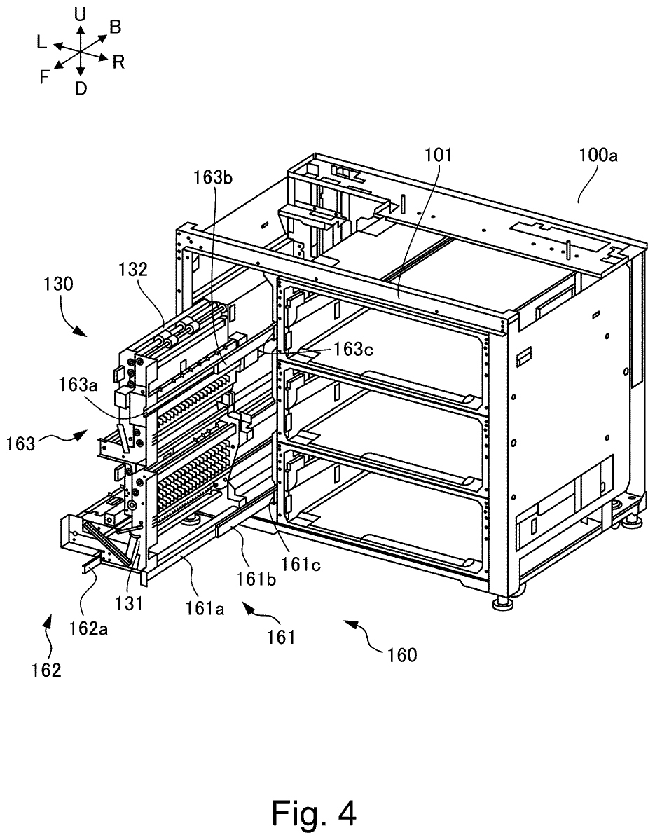

The vertical conveying portion 130 is provided movably in the horizontal direction by a moving mechanism 160 between an accommodated position (see FIG. 2A), in which the vertical conveying portion 130 is accommodated in the main assembly 100a, and a drawn-out position (see FIG. 4), in which the vertical conveying portion 130 is drawn out from the main assembly 100a. Hereinafter, the moving mechanism 160 will be described in detail using FIG. 4. FIG. 4 is a perspective view illustrating a state in which the vertical conveying portion 130 is drawn out from the main assembly 100a. Incidentally, the vertical conveying portion 130 becomes drawable as described below by opening a door 102 shown in FIG. 2A.

As shown in FIG. 4, the moving mechanism 160 includes a first mechanism 161, a second mechanism 162 and a third mechanism 163. The first mechanism 161 and the second mechanism 162 are disposed in a lower portion of an inner space of the frame 101, and are provided parallel to each other. The first mechanism 161 includes a first moving member 161a, a first auxiliary rail 161b and a first guide rail 161c. The first guide rail 161c is fixed to and supported by the frame 101 with the front and back direction as a longitudinal direction thereof, and to the first guide rail 161c, the first auxiliary rail 161b having an approximately rod shape with the front and back direction as a longitudinal direction thereof is provided slidably in the front and back direction. In addition, to the first auxiliary rail 161b, the first moving member 161a having an approximately rod shape with the front and back direction as a longitudinal direction thereof is provided slidably in the front and back direction. Thus, the first moving member 161a is provided movably in the front and back direction with respect to the frame 101.

Similar to the first mechanism 160, the second mechanism 162 includes a second moving member 162a, a second auxiliary rail 162b (not shown) and a second guide rail 162c (not shown). The second guide rail 162c is fixed to and supported by the frame 101 with the front and back direction as a longitudinal direction thereof, and to the second guide rail 162c, the second auxiliary rail 162b having an approximately rod shape with the front and back direction as a longitudinal direction thereof is provided slidably in the front and back direction as same as the first auxiliary rail 161b and the first guide rail 161c. In addition, to the second auxiliary rail 162b, the second moving member 162a having an approximately rod shape with the front and back direction as a longitudinal direction thereof is provided slidably in the front and back direction. Thus, the second moving member 162a is provided movably in the front and back direction with respect to the frame 101.

Here, the first moving member 161a and the second moving member 162a are examples of a moving portion and a first moving portion which support the vertical conveying portion 130. And the first moving member 161a and the second moving member 162a are movable between an accommodated position, in which the vertical conveying portion 130 is accommodated in the main assembly 100a, and a drawn-out position, in which the vertical conveying portion 130 becomes a state of being drawn-out from the main assembly 100a. In addition, the first guide rail 161c and the second guide rail 162c are examples of a guiding portion which supports the first moving member 161a and the second moving member 162a and guides them to the main assembly 100a. In other words, the moving portion and the first moving portion include the first moving member 161a and the second moving member 162a, which are disposed parallel to each other and are movable to the accommodated position and the drawn-out position while supporting the first conveying portion 131, respectively.

Furthermore, the third mechanism 163 includes a third moving member 163a, a third auxiliary rail 163b and a third guide rail 163c. The third guide rail 163c is fixed to and supported by the frame 101 with the front and back direction as a longitudinal direction thereof, and to the third guide rail 163c, the third auxiliary rail 163b having an approximately rod shape with the front and back direction as a longitudinal direction thereof is provided slidably in the front and back direction. In addition, to the third auxiliary rail 163b, the third moving member 163a having an approximately rod shape with the front and back direction as a longitudinal direction thereof is provided slidably in the front and back direction. Thus, the third moving member 163a is provided movably in the front and back direction with respect to the frame 101. The third moving member 163a supports the second conveying portion 132 and is movable between an accommodated position and a drawn-out position. In addition, the third guide rail 163c supports the third moving member 163a and guides the third moving member 163a to the main assembly 100a.

As shown in FIG. 3, as for the first conveying portion 131, the fixing thereof to the frame 101 can be released by removing the screws 134a and 134b. In addition, as for the second conveying portion 132, the fixing thereof to the frame 101 can be released by removing the screws 134c through 134f. The first conveying portion 131 and the second conveying portion 132, of which the fixing to the frame 101 have been released, are drawn out, as shown in FIG. 4, in a state of being supported by the first moving member 161a, the second moving member 162a and the third moving member 163a, which are movably provided to the frame 101. In the present Embodiment, the vertical conveying portion 130 is configured to be supported movably in the front and back direction by the moving mechanism 160, is drawn-out in the front direction F, and is mounted in the back direction B. In other words, the vertical conveying portion 130 is drawn out, in a case in which the first moving member 161a, the second moving member 162a and the third moving member 163a are moved from the accommodated position to the drawn-out position, from the main assembly 100a in the front direction F, which is a first direction and the horizontal direction. By this, it has a configuration in which the vertical conveying portion 130 can be held on the front direction F side of the main assembly 100a before being removed from the main assembly 100a.

### Vertical Conveyance Entrance Unit of the First Conveying Portion

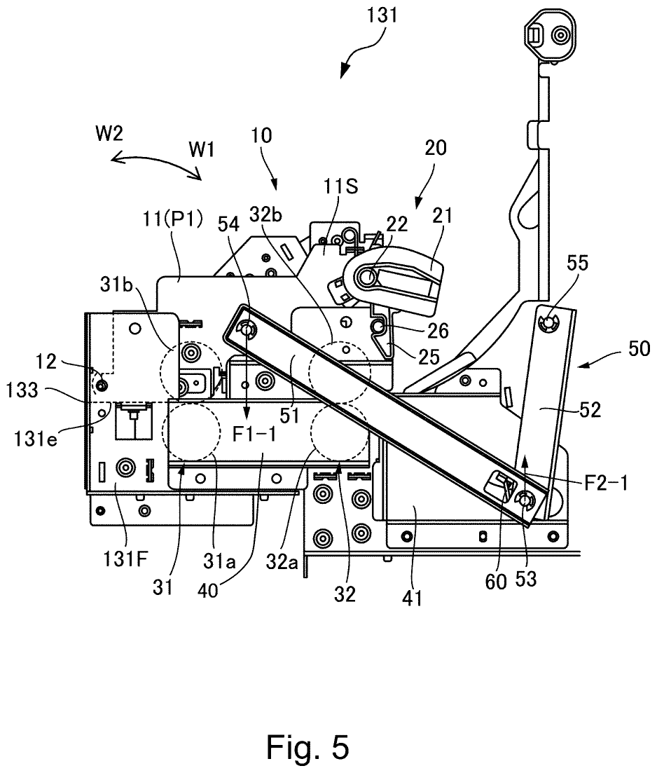

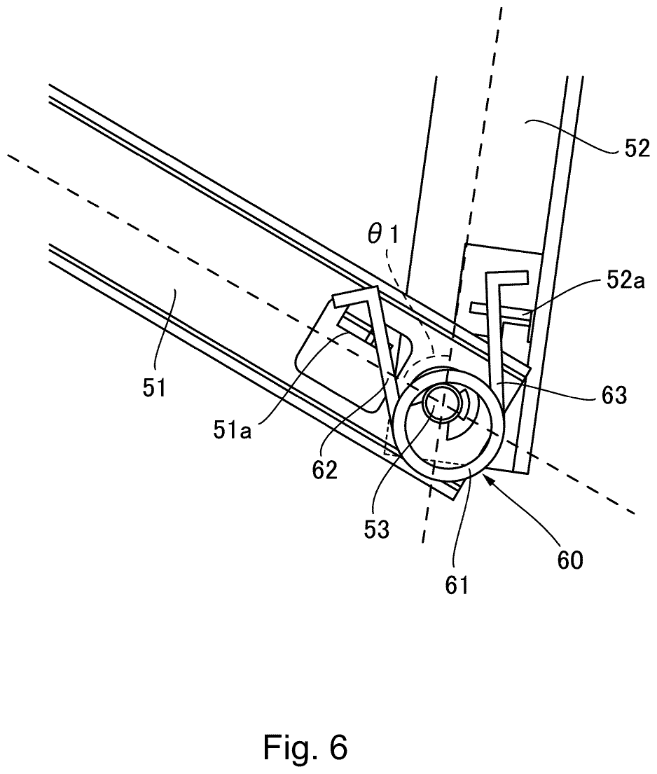

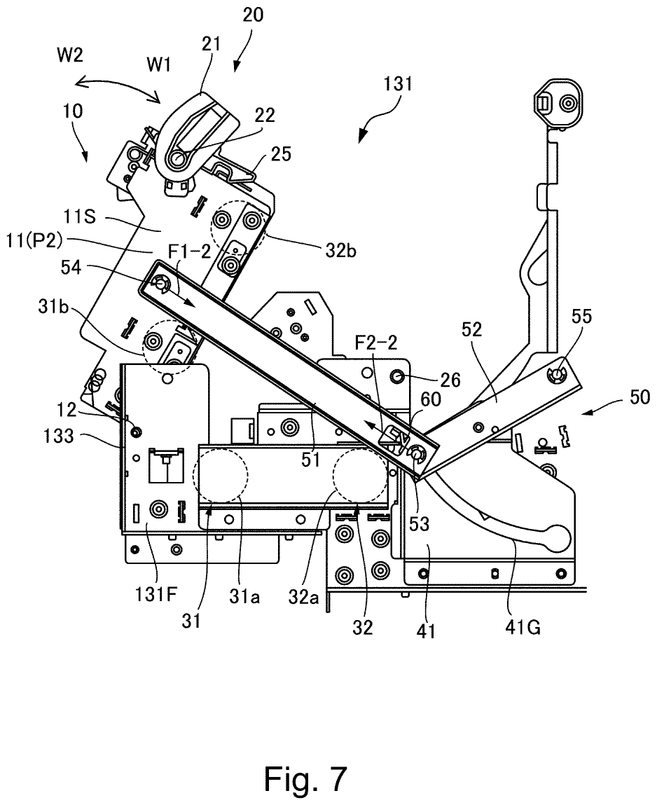

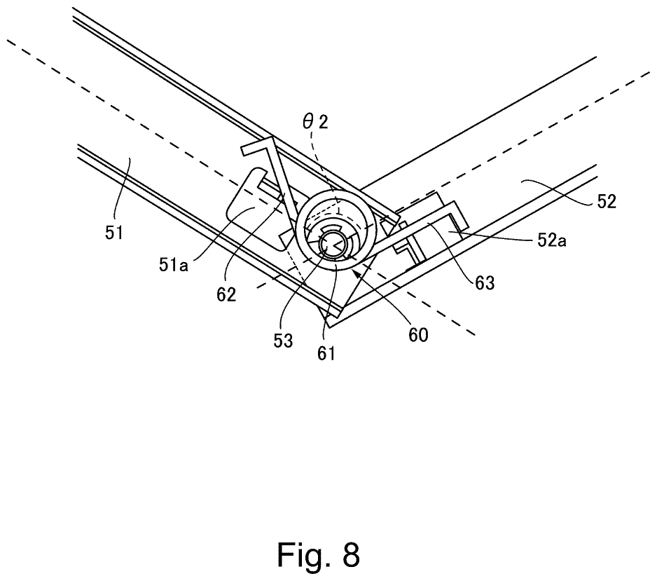

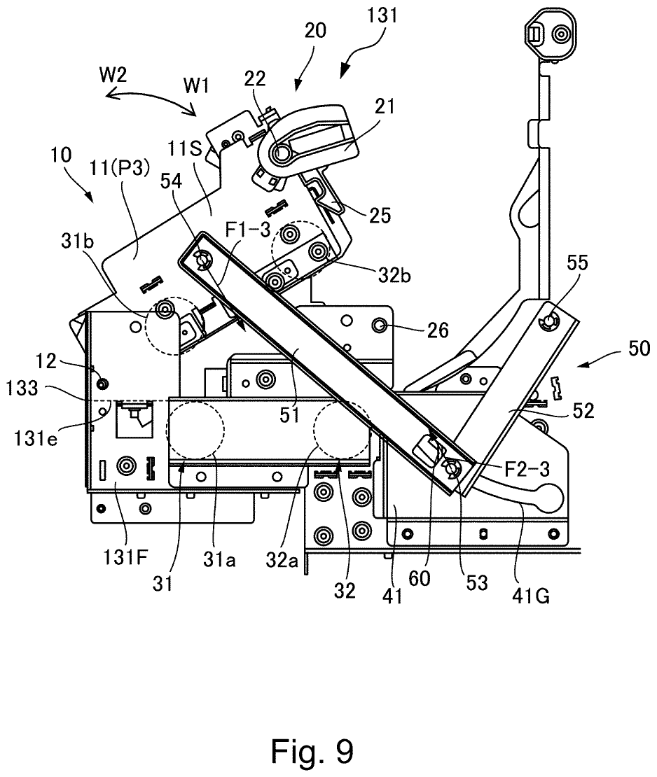

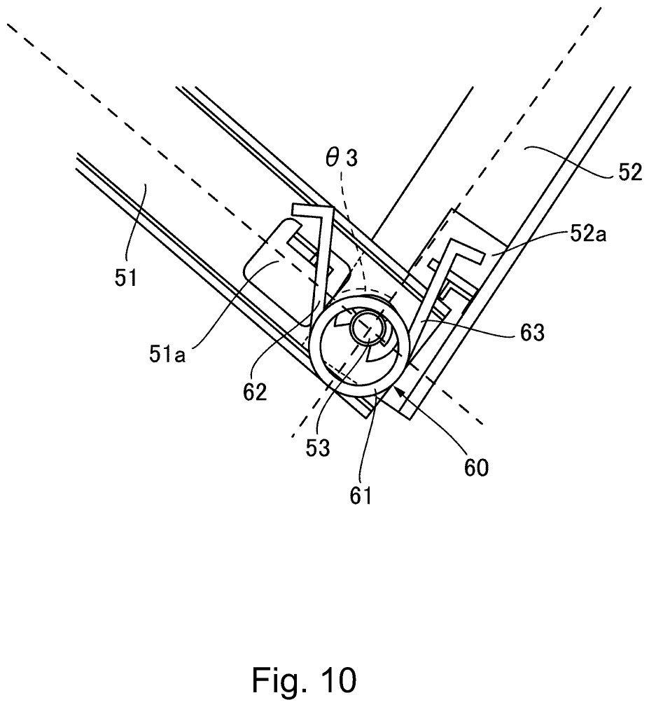

Next, a configuration of a vertical conveyance entrance unit 10 of the first conveying portion 131 according to the present Embodiment will be described using FIG. 5 through FIG. 10. FIG. 5 is a front view illustrating the vertical conveyance entrance unit 10 when a conveyance guide portion according to the present Embodiment is in a closed position. FIG. 6 is a perspective view illustrating a coupling portion of an interlocking link and a torsion coil spring when the conveyance guide portion according to the present Embodiment is in the closed position. FIG. 7 is a front view illustrating the vertical conveyance entrance unit when the conveyance guide portion according to the present Embodiment is in an opening position. FIG. 8 is a perspective view illustrating the coupling portion of the interlocking link and the torsion coil spring when the conveyance guide portion according to the present Embodiment is in the opening position. FIG. 9 is a front view illustrating the vertical conveyance entrance unit when the conveyance guide portion according to the present Embodiment is in an intermediary position. FIG. 10 is a perspective view illustrating the coupling portion of the interlocking link and the torsion coil spring when the conveyance guide portion according to the present Embodiment is in the intermediary position.

As shown in FIG. 5, FIG. 7 and FIG. 9, the first conveying portion 131 is provided with the vertical conveyance entrance unit 10. The vertical conveyance entrance unit 10 is constituted by, roughly, a supporting frame 131F as a supporting portion, a downside guide 40, a conveyance guide 11 as a conveyance guide portion, and a link mechanism 50 as an interlocking portion. The downside guide 40 is fixed to and supported by the supporting frame 131F, and the conveyance guide 11 on one side is supported rotatably about a rotation shaft 12 with respect to the supporting frame 131F. In other words, the conveyance guide 11 is supported by the supporting frame 131F so as to be openable and closable between a closed position P1 (see FIG. 5), where the conveyance guide 11 is closed with respect to the downside guide 40 to form the re-conveyance passage 131e as a conveyance passage, and an opening position P2 (see FIG. 7) where the conveyance guide 11 is opened with respect to the downside guide 40. Incidentally, the conveyance guide 11 is supported by the supporting frame 131F so as to pass through, upon opening/closing operation thereof, an intermediary position P3 (see FIG. 9) between the closed position P1 (see FIG. 5) and the opening position P2 (see FIG. 7).

The vertical conveyance entrance unit 10 is provided with a first conveyance roller pair 31 and a second conveyance roller pair 32 as conveying portions which convey the sheet S in the re-conveyance passage 131e. The first conveyance roller pair 31 includes a driving roller 31a which is driven by a motor and a driven roller 31b which follows the driving roller 31a. Of these, the driving roller 31a is provided to and rotatably supported by the downside guide 40, and the driven roller 31b is provided to and rotatably supported by the conveyance guide 11. Similarly, the second conveyance roller pair 32 includes a driving roller 32a which is driven by a motor and a driven roller 32b which follows the driving roller 32a. Of these, the driving roller 32a is provided to and rotatably supported by the downside guide 40, and the driven roller 32b is provided to and rotatably supported by the conveyance guide 11. And, in a state in which the conveyance guide 11 is in the closed position P1 with respect to the downside guide 40, the driving roller 31a and the driven roller 31b of the first conveyance roller pair 31 are in contact with each other to form a nip to convey the sheet S. Similarly, in the state in which the conveyance guide 11 is in the closed position P1, the driving roller 32a and the driven roller 32b of the second conveyance roller pair 32 is in contact with each other to form a nip to convey the sheet S.

In the conveyance guide 11 described above, to a side surface 11S thereof on the front direction F side, which is one side in a widthwise direction thereof perpendicular to the sheet conveyance direction D1, an operating portion 20 for performing the opening/closing operation (opening operation) of the conveyance guide 11 is provided. The operating portion 20 includes a grip 21 as a grip portion, which a user operates, and a supporting shaft 22, which is provided to the conveyance guide 11 and supports the grip 21 rotatably. In addition, the operating portion 20 includes a hook 25 fixed to the grip 21 and a fixing shaft 26 fixed to the supporting frame 131F and capable of being engaged with the hook 25. In addition, the grip 21 is urged by an urging member such as a spring in a direction in which the hook 25 engages the fixing shaft 26 (clockwise direction in FIG. 5) about the supporting shaft 22. In the operating portion 20 configured in this manner, by a user operating the grip 21 in a way of lifting upward (counterclockwise in FIG. 5), the hook 25 is separated or disengaged from the fixing shaft 26, and a lock (engagement) between the hook 25 and the fixing shaft 26 is released. By this, it becomes possible for the user, by keeping lifting up the grip 21, to move the conveyance guide 11 in an opening direction W2 from the closed position P1 to the opening position P2 (see FIG. 7) via the supporting shaft 22. Incidentally, when the user pushes the grip 21 or the conveyance guide 11 in a closing direction W1, or releases the grip 21 or the conveyance guide 11 and lets it fall naturally, the hook 25 and the fixing shaft 26 are engaged, and the conveyance guide 11 is locked in the closed position P1. In this manner, by the conveyance guide 11 being locked to the downside guide 40, it becomes possible to secure a conveyance force by the first conveyance roller pair 31 and the second conveyance roller pair 32 normally, and not to affect conveyance function.

In addition, at a position along the side surface 11S of the conveyance guide 11 described above, the link mechanism 50 is disposed. The link mechanism 50 includes a first link 51 as a first interlocking member of which one end is engaged with the conveyance guide 11 and a second link 52 as a second interlocking member of which one end is engaged with the supporting frame 131F and the other end is engaged with the first link 51. In addition, the link mechanism 50 includes a coupling shaft 53 as a coupling portion which rotatably couples the first link 51 and the second link 52. In detail, in the first link 51, one end thereof is engaged with a first engagement shaft 54, which is supported by the side surface 11S of the conveyance guide 11, in other words, the one end thereof is engaged with respect to the conveyance guide 11, and the other end thereof is engaged with the second link 52 by the coupling shaft 53. In addition, in the second link 52, one end thereof is engaged with a second engagement shaft 55, which is supported by the supporting frame 131F, in other words, the one end thereof is engaged with respect to the supporting frame 131F, and the other end thereof is engaged with the first link 51 by the coupling shaft 53. Incidentally, on a side surface on an opposite side to the side surface 11S of the conveyance guide 11, in other words, on the side surface on the other side of the conveyance guide 11, no mechanism corresponding to the link mechanism 50 is disposed.

In addition, as shown in FIG. 7, in a manner of being arranged side-by-side in the left and right direction with respect to the downside guide 40, a coupling guide member 41, which is fixed to and supported by the supporting frame 131F, is disposed. And, in the coupling guide member 41, a guiding groove 41G as a restricting portion which restricts positions in which the coupling shaft 53 described above makes slide movement thereof. By this, in a case in which the conveyance guide 11 is moved to be opened/closed, the link mechanism 50 is moved in interlocking therewith, but since a movement range of the coupling shaft 53 is restricted by the guiding groove 41G, it becomes possible to allow the link mechanism 50 to be moved stably, and especially to suppress shaking of the first link 51.

And, as shown in FIG. 6, a torsion coil spring 60, which is an example of a spring as an urging portion, is disposed in a vicinity of the coupling shaft 53. In the torsion coil spring 60, a coil main body 61 is formed by a spring wire being wound into a coil shape, and by the coupling shaft 53 being disposed through the coil main body 61, the torsion coil spring 60 is positioned and supported. In addition, the torsion coil spring 60 includes one end portion 62, which is one end of the spring wire extending from the coil main body 61, and the other end portion 63, which is the other end of the spring wire. The one end portion 62 is engagingly attached to a first washer 51a fixed to the first link 51, and the other end portion 63 is engagingly attached to a second washer 52a fixed to the second link 52. As a result, the urging force of the torsion coil spring 60 becomes larger as an angle formed between the first link 51 and the second link 52 gets smaller, and becomes smaller as the angle formed between the first link 51 and the second link 52 gets larger.

### Application of the Urging Force to the Conveyance Guide by the Link Mechanism and the Torsion Coil Spring

Next, application of the urging force to the conveyance guide 11 by the link mechanism 50 and the torsion coil spring 60 will be described using FIG. 5 through FIG. 10. By making the conveyance guide 11 described above be in the opening position P2 (see FIG. 7), even if the jam, etc. occurs in the re-conveyance passage 131e, for example, the jammed sheet can be checked and removed.

However, in recent years, because of demand for downsizing of an apparatus, it is required to utilize spaces inside the apparatus effectively, so that there is a case in which a movable angle in the opening/closing direction of a conveyance guide cannot be secured. In other words, also for the conveyance guide 11 described above according to the present Embodiment, it is not possible to secure an opening angle sufficiently in the case of being opened upward, and an opening/closing angle from the closed position P1 to the opening position P2 is less than 90 degrees. In the conveyance guide 11 in this manner, since a center of gravity does not exceed 90 degrees even in a state of being opened to the most, if there is no structure to maintain the position of the conveyance guide 11, the conveyance guide 11 may close by falling naturally from the opening position P2, which may cause damage, etc. due to impact thereof. Therefore, it is desirable to apply some pressing force (urging force) to the conveyance guide 11 to maintain the conveyance guide 11 in the opening position P2. However, as in Japanese Patent Application Laid-Open No. 2012-12170, for example, with a configuration in which a toggle spring presses a conveyance guide which is opened at less than 90 degrees, when a maximum point of an urging force is exceeded, the guide may be urged in a closing direction. Then, there is still a possibility that the damage etc. due to the impact upon closing, and it is not good for operability. Therefore, improvement of the operability upon opening/closing the conveyance guide 11 has been needed. Thus, in the vertical conveyance entrance unit 10 according to the present Embodiment, a force against an own weight of the conveyance guide 11 is generated by the link mechanism 50 and the torsion coil spring 60 described above, in other words, it is configured to urge the conveyance guide 11 in the opening direction.

In detail, as shown in FIG. 7, for example, suppose that the grip 21 is operated upward by a user and the conveyance guide 11 is placed in the opening position P2 which is opened to the most. In this case, by the own weight of the conveyance guide 11, a force F1-2 as a first force acts on the first link 51 from the first engagement shaft 54. A direction in which this force F1-2 acts is a direction W1 in which the conveyance guide 11 closes by its own weight since the conveyance guide 11 is opened less than 90 degrees with respect to the re-conveyance passage 131e (i.e., horizontal direction). In other words, the direction in which the force F1-2 acts is a tangential direction of a circle which passes through the first engagement shaft 54 and is centered on the rotation shaft 12. In addition, in the present Embodiment, it is configured that in the case in which the conveyance guide 11 is in the opening position P2, a longitudinal direction of the first link 51 is approximately in the direction W1 in which the conveyance guide 11 closes.

And, when the conveyance guide 11 is in the opening position P2 in this manner, as shown in FIG. 8, an angle formed between the longitudinal direction of the first link 51 and a longitudinal direction of the second link 52 becomes an angle θ2. Therefore, by the torsion coil spring 60, the urging force with which the first link 51 presses and urges the first engagement shaft 54 (i.e., the conveyance guide 11) by receiving a reaction force from the second link 52 becomes a force F2-2 corresponding to the angle θ2. This force F2-2 is larger than the force F1-2 described above, in other words, the conveyance guide 11 is pressed, by the urging force of the torsion coil spring 60, so as not to close by its own weight and is maintained in the opening position P2. Therefore, an event such that the conveyance guide 11 falls naturally to the closed position P1 and applies impact and generates the damage, etc., thereto is prevented. In addition, the angle θ2 formed between the first link 51 and the second link 52 at this time is an obtuse angle, i.e., it is wide open, so that it becomes possible to secure a working space for the user to remove the sheet in the re-conveyance passage 131e and improve workability.

Thereafter, as shown in FIG. 9, for example, assuming that the grip 21 is operated downward by the user and the conveyance guide 11 is positioned in the intermediary position P3 between the opening position P2 and the closed position P1. In this case, by the own weight of the conveyance guide 11, a force F1-3 acts on the first link 51 from the first engagement shaft 54. A direction in which the force F1-3 acts is, as described above, the direction W1 in which the conveyance guide 11 closes by its own weight, and is a tangential direction of the circle which passes through the first engagement shaft 54 and is centered on the rotation shaft 12. The force F1-3 when the conveyance guide 11 is in the intermediary position P3 becomes larger, since the conveyance guide 11 is moved in the direction W1 in which the conveyance guide 11 is closed and the center of gravity thereof gets apart in the horizontal direction from the rotational shaft 12, due to the own weight of the conveyance guide 11, than the force F1-2 when the conveyance guide 11 is in the opening position P2. In addition, when the conveyance guide 11 is in the intermediary position P3, the first link 51 is rotated so that the longitudinal direction thereof faces upward (clockwise direction in FIG. 9) more than when the conveyance guide 11 is in opening position P2. In other words, since the second link 52 is rotated about the second engagement shaft 55 and the coupling shaft 53 is guided downward by the guiding groove 41G described above, the position of the first engagement shaft 54 is lowered but the coupling shaft 53 is lowered more than that so that the longitudinal direction of the first link 51 faces upward.

And, when the conveyance guide 11 is in the intermediary position P3 in this manner, as shown in FIG. 10, the angle formed between the longitudinal direction of the first link 51 and the longitudinal direction of the second link 52 becomes an angle θ3. Therefore, by the torsion coil spring 60, the urging force with which the first link 51 presses and urges the first engagement shaft 54 (i.e., the conveyance guide 11) by receiving a reaction force from the second link 52 becomes a force F2-3 corresponding to the angle θ3. This force F2-3 becomes smaller as the conveyance guide 11 gets closed, and in the intermediary position P3 shown in FIG. 9, is smaller than the force F1-3 described above. Therefore, the conveyance guide 11 is, though urged by the urging force of the torsion coil spring 60, pressed to close by its own weight, so that the conveyance guide 11 moves in the direction W1 in which the conveyance guide 11 closes without being pushed by the user, for example. On the other hand, it becomes possible, with the force F2-3 acting as a load, to reduce a total force generated in the direction W1 in which the conveyance guide 11 closes than a case without the link mechanism 50 and the torsion coil spring 60.

Suppose that further thereafter, as shown in FIG. 5, the grip 21 is operated downward by the user, for example, and the conveyance guide 11 is in the closed position P1 or in a state just before the closed position P1. In this case, by the own weight of the conveyance guide 11, a force F1-1 in a vertical direction as a second force acts on the first link 51 from the first engagement shaft 54. A direction in which the force F1-1 acts on the first link 51 is, as described above, the direction W1 in which the conveyance guide 11 closes by its own weight, and is a tangential direction of the circle which passes through the first engagement shaft 54 and is centered on the rotation shaft 12. The force F1-1 when the conveyance guide 11 is in the closed position P1 becomes larger, since the conveyance guide 11 is moved in the direction W1 in which the conveyance guide 11 closes and the center of gravity thereof gets apart in the horizontal direction from the rotational shaft 12, due to the own weight of the conveyance guide 11, than the force F1-3 when the conveyance guide 11 is in the intermediary position P3 (FIG. 9). In addition, when the conveyance guide 11 is in the closed position P1, the first link 51 is rotated so that the longitudinal direction thereof faces upward (counterclockwise direction in FIG. 5) more than when the conveyance guide 11 is in the intermediary position P3. In other words, since the second link 52 is rotated about the second engagement shaft 55 and the coupling shaft 53 is guided downward by the guiding groove 41G described above, the position of the first engagement shaft 54 is lowered but the coupling shaft 53 is lowered more than that so that the longitudinal direction of the first link 51 faces upward.

And, when the conveyance guide 11 is in the closed position P1 in this manner, as shown in FIG. 6, the angle formed between the longitudinal direction of the first link 51 and the longitudinal direction of the second link 52 becomes an angle θ1. Therefore, by the torsion coil spring 60, the urging force with which the first link 51 presses and urges the first engagement shaft 54 (i.e., the conveyance guide 11) by receiving the reaction force from the second link 52 becomes a force F2-1 corresponding to the angle θ1. This force F2-1 becomes smaller as the conveyance guide 11 gets closed as described above, and is smaller in the closed position P1 shown in FIG. 5 than the force F1-1 described above, but becomes larger than the force F1-3 when the conveyance guide 11 is in the intermediary position P3. Therefore, the conveyance guide 11 is, though urged by the urging force of the torsion coil spring 60, pressed to close by its own weight, so that the conveyance guide 11 moves in the direction W1 in which the conveyance guide 11 closes without being pushed by the user, for example. However, it becomes possible, with the force F2-1 becoming a load larger than when in the intermediary position P3, to reduce the total force generated in the direction W1 in which the conveyance guide 11 closes than the case without the link mechanism 50 and the torsion coil spring 60. Therefore, it becomes possible to reduce a moving speed upon closing the conveyance guide 11 to the closed position P1, and it can be prevented that the conveyance guide 11 collides with the downside guide 40 and causes the damage, etc. In addition, since the force F1-1 generated by the own weight of the conveyance guide 11 is slightly larger than the force F2-1 generated by the torsion coil spring 60, it becomes possible for a user to close the conveyance guide 11 easily to the end and engage the hook 25 with the fixing shaft 26 easily. In this manner, since it becomes possible to make it unnecessary for a user to carefully operate the opening/closing of the conveyance guide 11 in particular, it becomes possible to improve the operability upon opening/closing the conveyance guide 11.

In addition, in the link mechanism 50, when the conveyance guide 11 is in the closed position P1, the angle θ1 formed between the first link 51 and the second link 52 becomes an acute angle, i.e., folded. Therefore, the link mechanism 50 is, along the side surface 11S of the conveyance guide 11, compactly accommodated between the supporting frame 131F, in other words, it becomes possible to realize space-saving.

In addition, the link mechanism 50 is disposed, in the widthwise direction (front and back direction), on the same side as the side on which the grip 21 of the operating portion 20 is provided to the conveyance guide 11. By this, an operating force with which the user operates the grip 21, the forces F1-1 through F1-3 due to the own weight of the conveyance guide 11 which is generated to the link mechanism 50, and the forces F2-1 through F2-3 which the torsion coil spring 60 generates act at a position along the side surface 11S on one side of the conveyance guide 11. Therefore, it is less likely for a force twisting in the widthwise direction to be generated upon opening/closing the conveyance guide 11, i.e., it becomes possible to suppress occurrence of twisting.

### Modified Example

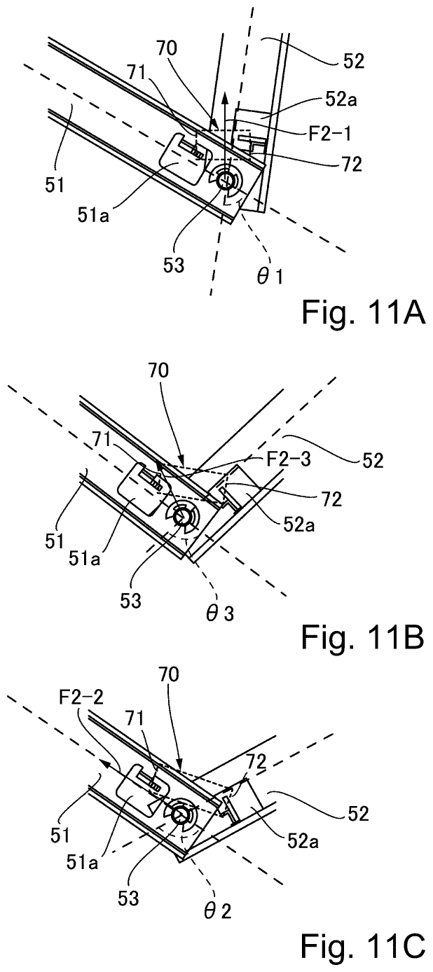

Next, a Modified Example in which the torsion coil spring 60 provided to the link mechanism 50 described above is replaced by a compression spring 70 will be described using FIG. 11. FIG. 11A is a perspective view illustrating a portion of a link mechanism and a compression spring when a conveyance guide according to another Embodiment is in a closed position. FIG. 11B is a perspective view illustrating the portion of the link mechanism and the compression spring when the conveyance guide according to the other Embodiment is in an intermediary position. FIG. 11C is a perspective view illustrating the portion of the link mechanism and the compression spring when the conveyance guide according to the other Embodiment is in an opening position.

As shown in FIG. 11A, FIG. 11B and FIG. 11C, in this Modified Example, in a vicinity of a coupling shaft 53 of a link mechanism 50, instead of the torsion coil spring 60 described above, the compression spring 70 is disposed. In detail, with one end 71 of the compression spring 70 being engagingly attached to a first washer 51a of a first link 51 and the other end 72 of the compression spring 70 being engagingly attached to a second washer 52a of a second link 52, the compression spring 70 is disposed. In other words, the compression spring 70 is compressed and disposed between the first washer 51a of the first link 51 and the second washer 52a of the second link 52.

Also in the Modified Example configured in this manner, as shown in FIG. 11A, when the conveyance guide 11 is in a closed position P1, a force F2-1 is generated by the link mechanism 50 according to an angle θ1 formed between the first link 51 and the second link 52, and the force F2-1 is applied to the conveyance guide 11. In addition, similarly, as shown in FIG. 11B, when the conveyance guide 11 is in an intermediary position P3, a force F2-3 is generated by the link mechanism 50 according to an angle θ3 formed between the first link 51 and the second link 52, and the force F2-3 is applied to the conveyance guide 11. Furthermore, similarly, as shown in FIG. 11C, when the conveyance guide 11 is in an opening position P2, a force F2-2 is generated by the link mechanism 50 according to an angle θ2 formed between the first link 51 and the second link 52, and the force F2-2 is applied to the conveyance guide 11. Therefore, also in this Modified Example, the same action and effect can be obtained as the torsion coil spring 60 described above. Since other portions than these are the same as in the Embodiment described above, description thereof is omitted.

### Summary of the Present Embodiment

The feeding module 100 according to the present Embodiment described above is, in the vertical conveyance entrance unit 10, provided with the link mechanism 50 which is engaged with the conveyance guide 11 and the supporting frame 131F, and which moves in interlocking with the opening/closing of the conveyance guide 11. In addition, the vertical conveyance entrance unit 10 is provided with the torsion coil spring 60 (compression spring 70) which applies the urging force urging, from the link mechanism 50 to the conveyance guide 11, in the direction W2 for opening the conveyance guide 11. When the conveyance guide 11 is in the opening position P2, the force F2-2 urging the conveyance guide 11 by the torsion coil spring 60 (compression spring 70) becomes larger than the force F1-2 acting on the link mechanism 50 in the direction W1 for closing the conveyance guide 11 by the own weight of the conveyance guide 11. By this, it becomes possible for the conveyance guide 11 to be maintained in the opening position P2 upon being opened. And, when the conveyance guide 11 is in the closed position P1, the force F2-1 urging the conveyance guide 11 by the torsion coil spring 60 (compression spring 70) becomes smaller than the force F1-1 acting on the link mechanism 50 in the direction W1 for closing the conveyance guide 11 by the own weight of the conveyance guide 11. By this, upon closing the conveyance guide 11 to the closed position P1, while the conveyance guide 11 is closed by its own weight, it becomes possible to reduce the moving speed of the conveyance guide 11 with the force F2-1. Therefore, since it becomes possible to make it unnecessary for a user to carefully operate the opening/closing of the conveyance guide 11, it becomes possible to improve the operability upon opening/closing the conveyance guide 11.

In addition, since the torsion coil spring 60 (compression spring 70) changes, according to the movement of the link mechanism 50 interlocking with the conveyance guide 11, the urging force urging the conveyance guide 11 in the opening direction W2, it becomes possible to realize the relationship among the forces as described above.

In addition, in particular, the link mechanism 50 is configured to include the first link 51 of which the one end is engaged with the conveyance guide 11 and the second link 52 of which the one end is engaged with the supporting frame 131F and the other end is engaged with the first link 51. Therefore, with such a simple mechanism, it becomes possible to realize the mechanism which moves in interlocking with the opening/closing of the conveyance guide 11.

Furthermore, the link mechanism 50 includes the coupling shaft 53 which rotatably couples the first link 51 and the second link 52. And the torsion coil spring 60 (compression spring 70) is disposed in the vicinity of the coupling shaft 53, and changes the magnitude of the force, which urges the conveyance guide 11 in the opening direction W2, according to the angle formed between the first link 51 and the second link 52, which are moved with the opening/closing of the conveyance guide 11. In other words, with such a simple mechanism, it becomes possible to realize the structure which changes the magnitude of the forces F2-1 through F2-3 urging the conveyance guide 11 in the opening direction W2 according to the opening/closing of the conveyance guide 11.

In addition, the grip 21 of the operating portion 20 and the link mechanism 50 are disposed along the side surface 11S on the one side in the widthwise direction of the conveyance guide 11. By this, the operating force of the user and the urging force by the torsion coil spring 60 (or compression spring 70) do not have a relationship of skew position, and it becomes possible to suppress the twist of the conveyance guide 11.

In addition, the feeding module 100 is provided with the main assembly 100a, and the vertical conveyance entrance unit 10 includes the supporting frame 131F, the conveyance guide 11, the grip 21, the first conveyance roller pair 31, the second conveyance roller pair 32, etc. And the vertical conveyance entrance unit 10 is movable between the accommodated position accommodated in the main assembly 100a and the drawn-out position drawn-out from the main assembly 100a in a drawing-out direction, and the side surface 11S of the conveyance guide 11 is the side surface disposed toward the drawing-out direction. In other words, the grip 21 is, in the state in which the vertical conveyance entrance unit 10 is drawn out from the main assembly 100a, on the front side, so that it becomes possible to improve the operability of the opening/closing operation of the conveyance guide 11. And by a fact that the link mechanism 50 is not disposed on a side surface on the opposite side to the side surface 11S of the conveyance guide 11 in the widthwise direction, it becomes possible to configure so that the operating force of the user and the urging force by the torsion coil spring 60 (or the compression spring 70) do not have the relationship of the skew position. By this, it becomes possible to suppress the twist of the conveyance guide 11.

### Possibility of Other Embodiments

Incidentally, in the present Embodiments described above, the configurations in which the first conveying portion 131 can be drawn out from the main assembly 100a are described, however, it is not limited thereto. For example, it may be a configuration in which the opening/closing operation of the conveyance guide 11 is performed by simply opening a door or a cover on the front side.

In addition, in the present Embodiment, the configurations in which the conveyance passage (a portion of the re-conveyance passage 131e) formed by the conveyance guide 11 of the vertical conveyance entrance unit 10 is disposed in the horizontal direction are described, however, it is not limited thereto. For example, even if the conveyance passage formed by the conveyance guide 11 is inclined about 10 degrees, if the center of gravity of the conveyance guide 11 does not exceed a line in the vertical direction passing through the rotational shaft 12 in the state of being opened to the most, it is possible to configure in the same manner as in the present Embodiments. In other words, the horizontal direction does not have to be strictly horizontal, but refers to a direction which is along the horizontal direction, and it can be said as the horizontal direction even if it is inclined in a range of 10 degrees, for example. In addition, the direction in which the conveyance guide 11 is opened may also be opposite in the left and right direction.

In addition, in the present Embodiment, the torsion coil spring 60 and the compression spring 70 are exemplified and described as the urging portion, however, it is not limited thereto. For example, it may be a spring such as rubber, in other words, it may be anything as long as an urging force thereof can be changed according to the angle formed between the first link 51 and the second link 52. In other words, it is sufficient for the urging portion to be a thing of which an urging force thereof can be changed according to the movement of the link mechanism 50 interlocking with the opening/closing of the conveyance guide 11. Specifically, it is sufficient for the urging portion to be a thing which applies an urging force larger than the own weight of the conveyance guide 11 at the opening position P2 thereof to the conveyance guide 11, and applies an urging force smaller than the own weight of the conveyance guide 11 in the closed position P1.

In addition, in the Embodiments described above, the cases in which the present invention is applied to the feeding module 100 as an example of the sheet conveying device are described, however, it is not limited thereto. For example, the present invention may be applied to the printing module 200, or may be applied to other modules such as the reversing module 600 and the discharging module 700. Furthermore, as the sheet conveying device, it can be applied to an inspection apparatus which reads and inspects the image of the sheet after the image formation and an automatic document feeding apparatus which feeds an original of which an image is read.

In addition, in the Embodiments described above, the cases in which the image forming system is applied to the inkjet recording system 1 of the inkjet recording type are described, however, it is not limited thereto but may be applied to an image forming apparatus of an electrophotographic type.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-205190 filed on Nov. 26, 2024, which is hereby incorporated by reference herein in its entirety.

1. A sheet conveying device comprising:
a supporting portion;
a conveyance guide portion supported by the supporting portion, openable and closable between (1) a closed position where a sheet conveyance passage through which a sheet is conveyed is formed and (2) an opening position where the sheet conveyance passage is opened, and configured to guide the sheet;
an interlocking portion engaged with the conveyance guide portion and the supporting portion, and configured to move in interlocking with opening/closing of the conveyance guide portion; and
an urging portion configured to apply an urging force to the interlocking portion and the conveyance guide portion in a direction for opening the conveyance guide portion toward the opening position,
wherein the urging force is (1) larger than a first force acting on the interlocking portion in a direction for closing the conveyance guide portion in a case in which the conveyance guide portion is in the opening position, and (2) smaller than a second force acting on the interlocking portion in the direction for closing the conveyance guide portion in a case in which the conveyance guide portion is in the closed position.

2. The sheet conveying device according to claim 1, wherein the first force and the second force are forces acted by own weight of the conveyance guide portion.

3. The sheet conveying device according to claim 1, wherein the urging portion changes the urging force according to movement of the interlocking portion.

4. The sheet conveying device according to claim 3, wherein the interlocking portion includes (1) a first interlocking member of which one end is engaged with the conveyance guide portion, and (2) a second interlocking member of which one end is engaged with the supporting portion and the other end is engaged with the first interlocking member.

5. The sheet conveying device according to claim 4, wherein the interlocking portion includes a coupling portion configured to rotatably couple the first interlocking member and the second interlocking member, and
wherein the urging portion is disposed in a vicinity of the interlocking portion and changes the urging force according to an angle formed between the first interlocking member and the second interlocking member which are moved with the opening/closing of the conveyance guide portion.

6. The sheet conveying device according to claim 5, wherein the urging portion is a spring of which one end is engaged with the first interlocking member and the other end is engaged with the second interlocking member.

7. The sheet conveying device according to claim 5, further comprising a restricting portion configured to restrict a movement range of the coupling portion.

8. The sheet conveying device according to claim 1, wherein the conveyance guide portion forms the sheet conveyance passage so as to be in a horizontal direction in the closed position and is opened upward toward the opening position.

9. The sheet conveying device according to claim 8, wherein an opening/closing angle, of the conveyance guide portion, from the closed position to the opening position is less than 90 degrees.

10. The sheet conveying device according to claim 1, further comprising a grip portion disposed at a side surface of one side of the conveyance guide portion in a widthwise direction perpendicular to a conveyance direction of the sheet,
wherein the interlocking portion is disposed along the side surface.

11. The sheet conveying device according to claim 10, further comprising:
a main assembly; and
a conveying unit including the supporting portion, the conveyance guide portion, the grip portion and a conveying portion configured to convey the sheet conveyed to the sheet conveyance passage,
wherein the conveying unit is movable between (1) an accommodated position accommodated in the main assembly and (2) a drawn-out position drawn-out from the main assembly in a drawing-out direction, and
wherein the side surface of the one side of the conveyance guide portion is a side surface disposed toward the drawing-out direction.

12. The sheet conveying device according to claim 10, the interlocking portion is not disposed on a side surface of the other side of the conveyance guide portion.

13. The sheet conveying device according to claim 1, further comprising:
an accommodating portion configured to accommodate a plurality of sheets; and
a feeding portion configured to feed the sheet accommodated in the accommodating portion to an image forming portion configured to form an image on the sheet.

14. The sheet conveying device according to claim 13, wherein the sheet conveyance passage is a re-conveyance passage through which the sheet of which the image is formed on a first side by the image forming portion is conveyed.

15. An image forming system comprising:
an image forming apparatus including an image forming portion configured to form an image on a sheet; and
the sheet conveying device according to claim 1.
